(19) United States
(12) Patent Application Publication
(10) Pub. No.: US 2005/0041927 A1
(43) Pub. Date: Feb. 24, 2005

(54) Optical fiber connector

(76) Inventor: Li-Seng Chung, Hsintien City (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/657,912

(22) Filed: Sep. 9, 2003

(51) Int. Cl. G02B 6/38

(52) U.S. Cl. 385/55

(57) ABSTRACT

An optical fiber connector includes two connecting seats each having a first side formed with a plane and a second side integrally formed with an insertion hole extended to the plane, and a connecting tube mounted between the connecting seats. Thus, each of the connecting seats is integrally formed with the insertion hole, and the two ends of the connecting tube are inserted into the insertion hole of each of the connecting seats respectively, so that the two optical fiber cables inserted into the connecting tube can form a co-axial connection state and can be connected with each other exactly.

### BACKGROUND OF THE INVENTION

1. Field of the Invention

The present invention relates to an optical fiber connector, and more particularly to an optical fiber connector, wherein the two optical fiber cables inserted into the connecting tube through the insertion hole of each of the connecting seats can form a co-axial connection state and can be connected with each other exactly.

2. Description of the Related Art

A conventional optical fiber connector 7 in accordance with the prior art shown in FIG. 27 comprises a first connecting member 71 having a plane 711 and a positioning sleeve 712 inserted into the plane 711, a second connecting member 72 having a plane 721 rested on the plane 711 of the first connecting member 71 and a positioning sleeve 722 inserted into the plane 721, and a connecting tube 73 having a first end 731 inserted into the positioning sleeve 712 of the first connecting member 71 and a second end 732 inserted into the positioning sleeve 722 of the second connecting member 72.

However, the positioning sleeve 712 is inserted into the plane 711 of the first connecting member 71 to combine with the first connecting member 71, and the positioning sleeve 722 is inserted into the plane 721 of the second connecting member 72 to combine with the second connecting member 72, so that the two positioning sleeves 712 and 722 are not aligned with each other easily, thereby increasing difficulty in the working process and decreasing the precision of the products. In addition, the optical fiber cable cannot be mounted on and removed from the conventional optical fiber connector 7 easily and rapidly for replacement, thereby increasing the testing time and decreasing the testing efficiency.

Another conventional optical fiber connector in accordance with the prior art shown in FIG. 28 comprises two connecting members 71A each having a plane 711A and a positioning sleeve 712A inserted into the plane 711A, and a connecting tube 74A having two ends each inserted into the positioning sleeve 712A of the respective connecting member 71A.

However, the positioning sleeve 712A is inserted into the plane 711A of the connecting member 71A to combine with the connecting member 71A, so that the two positioning sleeves 712A are not aligned with each other easily, thereby increasing difficulty in the working process and decreasing the precision of the products. In addition, the optical fiber cable cannot be mounted on and removed from the conventional optical fiber connector easily and rapidly for replacement, thereby increasing the testing time and decreasing the testing efficiency.

Another conventional optical fiber connector 8 in accordance with the prior art shown in FIGS. 29 and 30 comprises a connecting seat 81 formed with an insertion hole 812 and an inner thread 811, a connecting sleeve 82 mounted on the connecting seat 81 and formed with an insertion hole 822 and having an outer thread 821 screwed into the inner thread 811 of the connecting seat 81, and a connecting tube 83 having two ends inserted into the insertion hole 812 of the connecting seat 81 and the insertion hole 822 of the connecting sleeve 82 respectively.

However, the insertion hole 812 of the connecting seat 81 and the insertion hole 822 of the connecting sleeve 82 are not aligned with each other easily, thereby increasing difficulty in the working process and decreasing the precision of the products. In addition, the optical fiber cable cannot be mounted on and removed from the conventional optical fiber connector 8 easily and rapidly for replacement, thereby increasing the testing time and decreasing the testing efficiency.

Another conventional optical fiber connector 9 in accordance with the prior art shown in FIG. 31 comprises a connecting seat 91 having a center formed with a connecting hole 913 having a first end formed with a first insertion hole 911 having an end face formed with a first inner thread 9111 and a second end formed with a second insertion hole 912 having an end face formed with a second inner thread 9121, a first connecting sleeve 93 having an outer wall formed with an outer thread 933 screwed into the first inner thread 9111 of the connecting seat 91 and an inner wall formed with a first receiving hole 931, a first connecting tube 92 having two ends inserted into the first insertion hole 911 of the connecting seat 91 and the first receiving hole 931 of the first connecting sleeve 93 respectively, a second connecting sleeve 95 having an outer wall formed with an outer thread 951 screwed into the second inner thread 9121 of the connecting seat 91 and an inner wall formed with a second receiving hole 952, and a second connecting tube 94 having two ends inserted into the second insertion hole 912 of the connecting seat 91 and the second receiving hole 952 of the second connecting sleeve 95 respectively. In addition, the first receiving hole 931 of the first connecting sleeve 93 has an end formed with a first catch edge 932 rested on the first connecting tube 92, and the second connecting tube 94 has an outer wall formed with a second catch edge 941 rested on the second connecting sleeve 95.

However, the first insertion hole 911 and the second insertion hole 912 of the connecting seat 91 are not aligned with each other easily, thereby increasing difficulty in the working process and decreasing the precision of the products. In addition, the optical fiber cable cannot be mounted on and removed from the conventional optical fiber connector 9 easily and rapidly for replacement, thereby increasing the testing time and decreasing the testing efficiency.

### SUMMARY OF THE INVENTION

The primary objective of the present invention is to provide an optical fiber connector, wherein each of the connecting seats is integrally formed with an extension portion having a center integrally formed with an insertion hole, and the two ends of the connecting tube are inserted into the insertion hole of each of the connecting seats respectively, so that the two optical fiber cables inserted into the connecting tube through the insertion hole of each of the connecting seats can form a co-axial connection state and can be connected with each other exactly.

Another objective of the present invention is to provide an optical fiber connector, wherein each of the connecting seats is integrally formed with an extension portion having a center integrally formed with an insertion hole, thereby simplifying the manufacturing procedures, and thereby decreasing costs of fabrication.

A further objective of the present invention is to provide an optical fiber connector, wherein each of the connecting seats is integrally formed with an extension portion having a center integrally formed with an insertion hole, thereby enhancing the precision of size of each part.

A further objective of the present invention is to provide an optical fiber connector, wherein the first connecting end and the second connecting end of the connecting tube have different diameters and are co-axial with each other, so that the connecting tube maintains a co-axial connection state, so that the two optical fiber cables can be connected with each other exactly.

In accordance with the present invention, there is provided an optical fiber connector, comprising:
two connecting seats each having a first side formed with a plane and a second side integrally formed with at least one insertion hole extended to the plane of the first side; and
at least one connecting tube mounted between the connecting seats and having two ends each inserted into the insertion hole of a respective one of the connecting seats.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of an optical fiber connector in accordance with the preferred embodiment of the present invention;

FIG. 2 is an exploded perspective view of an optical fiber connector in accordance with another embodiment of the present invention;

FIG. 3 is an exploded perspective view of an optical fiber connector in accordance with another embodiment of the present invention;

FIG. 4 is an exploded perspective view of an optical fiber connector in accordance with another embodiment of the present invention;

FIG. 5 is an exploded perspective view of an optical fiber connector in accordance with another embodiment of the present invention;

FIG. 6 is an exploded perspective view of an optical fiber connector in accordance with another embodiment of the present invention;

FIG. 7 is an exploded perspective view of an optical fiber connector in accordance with another embodiment of the present invention;

FIG. 8 is an exploded perspective view of an optical fiber connector in accordance with another embodiment of the present invention;

FIG. 9 is an exploded perspective view of an optical fiber connector in accordance with another embodiment of the present invention;

FIG. 10 is an exploded perspective view of an optical fiber connector in accordance with another embodiment of the present invention;

FIG. 11 is an exploded perspective view of an optical fiber connector in accordance with another embodiment of the present invention;

FIG. 12 is an exploded perspective view of an optical fiber connector in accordance with another embodiment of the present invention;

FIG. 13 is an exploded perspective view of an optical fiber connector in accordance with another embodiment of the present invention;

FIG. 14 is an exploded perspective view of an optical fiber connector in accordance with another embodiment of the present invention;

FIG. 15 is an exploded perspective view of an optical fiber connector in accordance with another embodiment of the present invention;

FIG. 16 is an exploded perspective view of an optical fiber connector in accordance with another embodiment of the present invention;

FIG. 17 is an exploded perspective view of an optical fiber connector in accordance with another embodiment of the present invention;

FIG. 18 is an exploded perspective view of an optical fiber connector in accordance with another embodiment of the present invention;

FIG. 19 is an exploded perspective view of an optical fiber connector in accordance with another embodiment of the present invention;

FIG. 20 is an exploded perspective view of an optical fiber connector in accordance with another embodiment of the present invention;

FIG. 21 is an exploded perspective view of an optical fiber connector in accordance with another embodiment of the present invention;

FIG. 22 is an exploded perspective view of an optical fiber connector in accordance with another embodiment of the present invention;

FIG. 23 is an exploded perspective view of an optical fiber connector in accordance with another embodiment of the present invention;

FIG. 24 is an exploded perspective view of an optical fiber connector in accordance with another embodiment of the present invention;

FIG. 25 is an exploded perspective view of an optical fiber connector in accordance with another embodiment of the present invention;

FIG. 26 is an exploded perspective view of an optical fiber connector in accordance with another embodiment of the present invention;

FIG. 27 is an exploded perspective view of a conventional connector in accordance with the prior art;

FIG. 28 is an exploded perspective view of another conventional connector in accordance with the prior art;

FIG. 29 is an exploded perspective view of another conventional connector in accordance with the prior art;

FIG. 30 is a plan exploded cross-sectional view of the conventional connector as shown in FIG. 29; and

FIG. 31 is a plan exploded cross-sectional view of another conventional connector in accordance with the prior art.

### DETAILED DESCRIPTION OF THE INVENTION

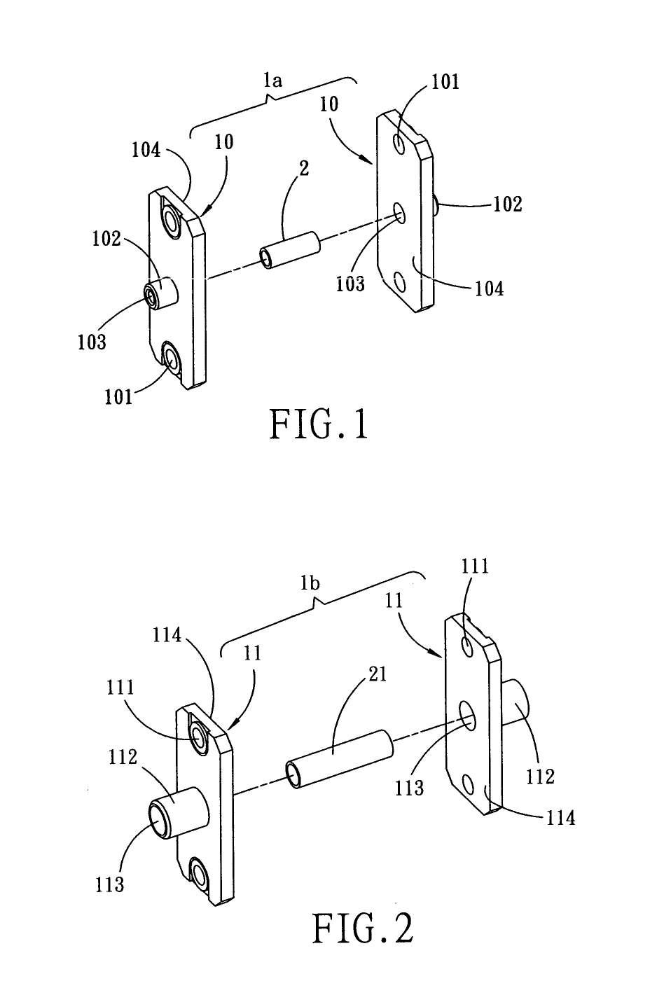

Referring to the drawings and initially to FIG. 1, an optical fiber connector 1a (LC type) in accordance with the preferred embodiment of the present invention comprises two connecting seats 10, and a connecting tube 2 mounted between the connecting seats 10.

Each of the connecting seats 10 has a first side formed with a plane 104 and a second side integrally formed with an extension portion 102 extended outward therefrom. The extension portion 102 of each of the connecting seats 10 has a center integrally formed with an insertion hole 103 extended to the plane 104 of the first side. Preferably, the insertion hole 103 of the extension portion 102 of each of the connecting seats 10 is vertical to the plane 104 of the first side. Each of the connecting seats 10 has a periphery formed with a plurality of positioning holes 101 for passage of bolts (not shown) or other combination members, such-that the connecting seats 10 are combined with each other.

The connecting tube 2 is a straight tube and has two ends each inserted into the insertion hole 103 of a respective one of the connecting seats 10.

Thus, two optical fiber cables (not shown) having the same diameter can be inserted into the connecting tube 2 through the insertion hole 103 of each of the connecting seats 10 to form a co-axial connection state.

Referring to FIG. 2, an optical fiber connector 1b (LC type) in accordance with another embodiment of the present invention comprises two connecting seats 11, and a connecting tube 21 mounted between the connecting seats 11.

Each of the connecting seats 11 has a first side formed with a plane 114 and a second side integrally formed with an extension portion 112 extended outward therefrom. The extension portion 112 of each of the connecting seats 11 has a center integrally formed with an insertion hole 113 extended to the plane 114 of the first side. Preferably, the insertion hole 113 of the extension portion 112 of each of the connecting seats 11 is vertical to the plane 114 of the first side. In addition, the insertion hole 113 of each of the connecting seats 11 has a diameter larger than that of the insertion hole 103 of each of the connecting seats 10. Each of the connecting seats 11 has a periphery formed with a plurality of positioning holes 111 for passage of bolts (not shown) or other combination members, such that the connecting seats 11 are combined with each other.

The connecting tube 21 is a straight tube and has two ends each inserted into the insertion hole 113 of a respective one of the connecting seats 11. In addition, the connecting tube 21 has a diameter larger than that of the connecting tube 2.

Thus, two optical fiber cables (not shown) having the same diameter can be inserted into the connecting tube 21 through the insertion hole 113 of each of the connecting seats 11 to form a co-axial connection state.

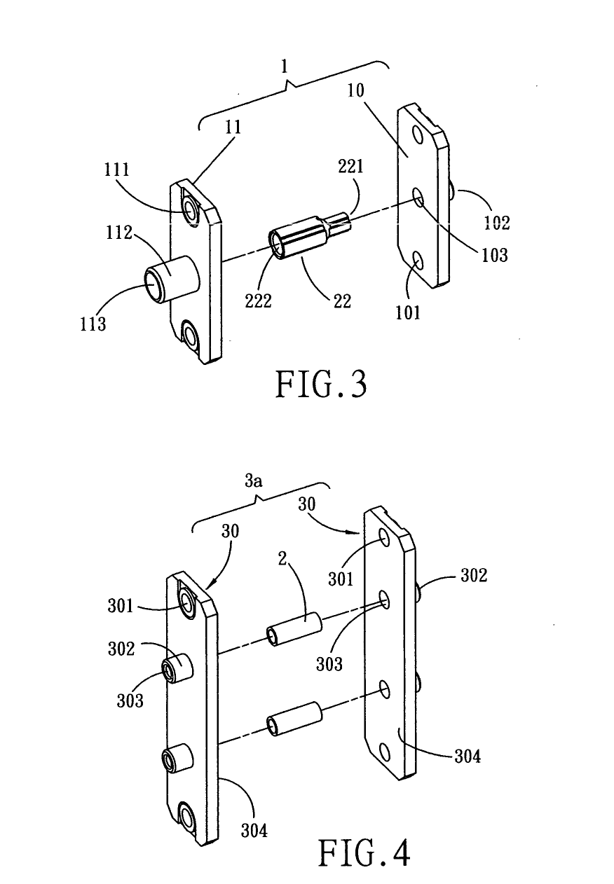

Referring to FIG. 3, an optical fiber connector 1 (LC type) in accordance with another embodiment of the present invention comprises two connecting seats 10 and 11, and a connecting tube 22 mounted between the connecting seats 10 and 11.

The connecting tube 22 has a first connecting end 221 inserted into the insertion hole 103 of the connecting seat 10 and a second connecting end 222 inserted into the insertion hole 113 of the connecting seat 11. In addition, the first connecting end 221 and the second connecting end 222 of the connecting tube 22 have different diameters and are co-axial with each other.

Thus, two optical fiber cables (not shown) having different diameters can be inserted into the connecting tube 22 through the insertion hole 103 of the connecting seat 10 and the insertion hole 113 of the connecting seat 11 to form a co-axial connection state.

Referring to FIG. 4, an optical fiber connector 3a (MU type) in accordance with another embodiment of the present invention comprises two connecting seats 30, and two connecting tubes 2 each mounted between the connecting seats 30.

Each of the connecting seats 30 has a first side formed with a plane 304 and a second side integrally formed with two extension portions 302 each extended outward therefrom. Each of the extension portions 302 of each of the connecting seats 30 has a center integrally formed with an insertion hole 303 extended to the plane 304 of the first side. Preferably, the insertion hole 303 of each of the connecting seats 30 is vertical to the plane 304 of the first side. Each of the connecting seats 30 has a periphery formed with a plurality of positioning holes 301 for passage of bolts (not shown) or other combination members, such that the connecting seats 30 are combined with each other.

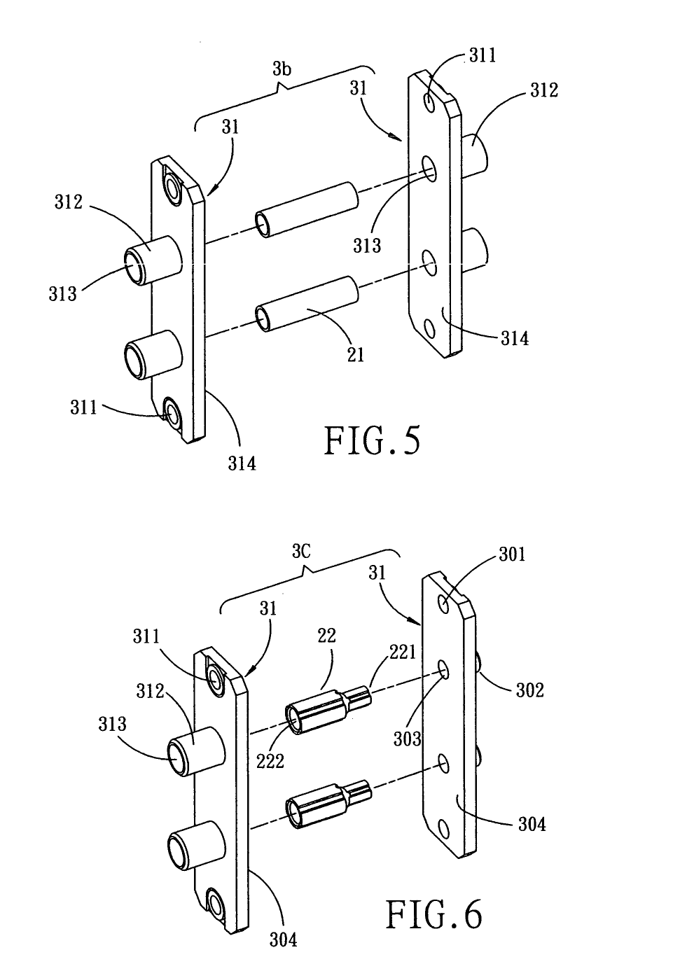

Referring to FIG. 5, an optical fiber connector 3b (MU type) in accordance with another embodiment of the present invention comprises two connecting seats 31, and two connecting tubes 21 each mounted between the connecting seats 31.

Each of the connecting seats 31 has a first side formed with a plane 314 and a second side integrally formed with two extension portions 312 each extended outward therefrom. Each of the extension portions 312 of each of the connecting seats 31 has a center integrally formed with an insertion hole 313 extended to the plane 314 of the first side. Preferably, the insertion hole 313 of each of the connecting seats 31 is vertical to the plane 314 of the first side. Each of the connecting seats 31 has a periphery formed with a plurality of positioning holes 311 for passage of bolts (not shown) or other combination members, such that the connecting seats 31 are combined with each other.

Referring to FIG. 6, an optical fiber connector 3c (MU type) in accordance with another embodiment of the present invention comprises two connecting seats 30 and 31, and two connecting tubes 22 each mounted between the connecting seats 30 and 31.

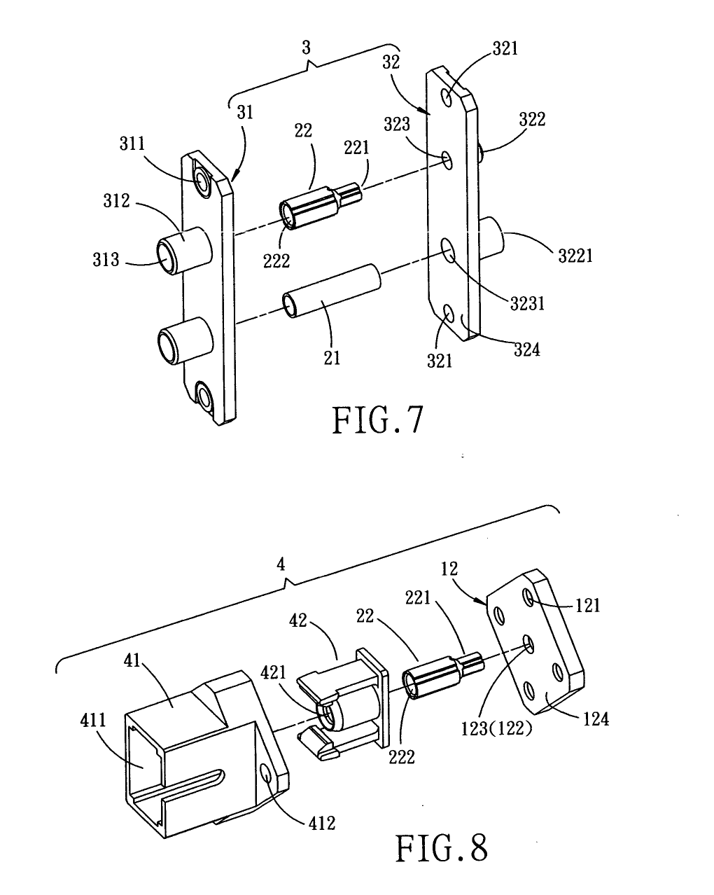

Referring to FIG. 7, an optical fiber connector 3 (MU type) in accordance with another embodiment of the present invention comprises two connecting seats 31 and 32, and two connecting tubes 21 and 22 each mounted between the connecting seats 31 and 32.

The connecting seat 32 has a first side formed with a plane 324 and a second side integrally formed with two extension portions 322 and 3221 each extended outward therefrom. Each of the extension portions 322 and 3221 of the connecting seat 32 has a center integrally formed with an insertion hole 323 and 3231 extended to the plane 324 of the first side. Preferably, each of the insertion holes 323 and 3231 of the connecting seat 32 is vertical to the plane 324 of the first side. In addition, the insertion holes 323 and 3231 of the connecting seat 32 have different diameters. The connecting seat 32 has a periphery formed with a plurality of positioning holes 321.

Referring to FIG. 8, an optical fiber connector 4 (SC type) in accordance with another embodiment of the present invention comprises two connecting seats 12 and 41, an insertion member 42 inserted into the connecting seat 41, and a connecting tube 22 mounted between the connecting seat 12 and the insertion member 42.

The connecting seat 12 has a first side formed with a plane 124 and a second side integrally formed with an extension portion 122 extended outward therefrom. The extension portion 122 of the connecting seat 12 has a center integrally formed with an insertion hole 123 extended to the plane 124 of the first side for insertion of the first connecting end 221 of the connecting tube 22. Preferably, the insertion hole 123 of the connecting seat 12 is vertical to the plane 124 of the first side. The connecting seat 12 has a periphery formed with a plurality of positioning holes 121.

The connecting seat 41 has an inside formed with a receiving recess 411 for receiving the insertion member 42 and has a periphery formed with a plurality of positioning holes 412.

The insertion member 42 has a center integrally formed with an insertion hole 421 for insertion of the second connecting end 222 of the connecting tube 22. In addition, the insertion hole 123 of the connecting seat 12 and the insertion hole 421 of the insertion member 42 have different diameters.

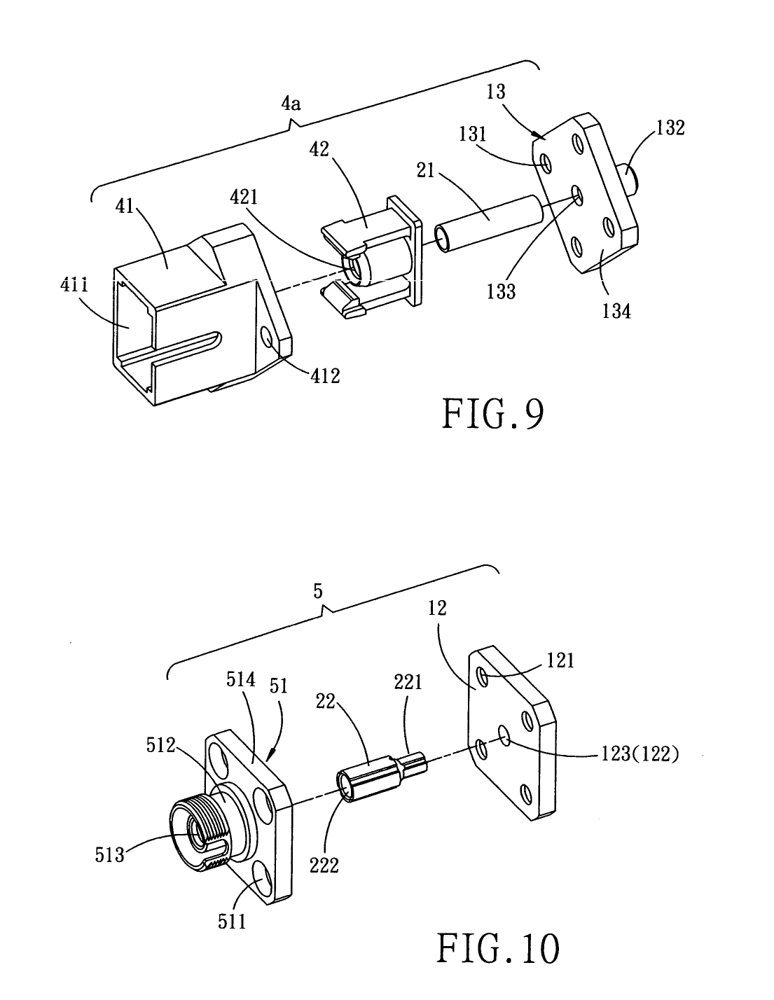

Referring to FIG. 9, an optical fiber connector 4a (SC type) in accordance with another embodiment of the present invention comprises two connecting seats 13 and 41, an insertion member 42 inserted into the connecting seat 41, and a connecting tube 21 mounted between the connecting seat 13 and the insertion member 42.

The connecting seat 13 has a first side formed with a plane 134 and a second side integrally formed with an extension portion 132 extended outward therefrom. The extension portion 132 of the connecting seat 13 has a center integrally formed with an insertion hole 133 extended to the plane 134 of the first side. Preferably, the insertion hole 133 of the connecting seat 13 is vertical to the plane 134 of the first side. The connecting seat 13 has a periphery formed with a plurality of positioning holes 131.

In addition, the insertion hole 133 of the connecting seat 13 and the insertion hole 421 of the insertion member 42 have the same diameter. Thus, the two ends of the connecting tube 21 are inserted into the insertion hole 133 of the connecting seat 13 and the insertion hole 421 of the insertion member 42 respectively.

Referring to FIG. 10, an optical fiber connector 5 (FC type) in accordance with another embodiment of the present invention comprises two connecting seats 12 and 51, and a connecting tube 22 mounted between the connecting seats 12 and 51.

The connecting seat 51 has a first side formed with a plane 514 and a second side integrally formed with a threaded extension portion 512 extended outward therefrom. The extension portion 512 of the connecting seat 51 has a center integrally formed with an insertion hole 513 extended to the plane 514 of the first side for insertion of the second connecting end 222 of the connecting tube 22. Preferably, the insertion hole 513 of the connecting seat 51 is vertical to the plane 514 of the first side. The connecting seat 51 has a periphery formed with a plurality of positioning holes 511. In addition, the insertion hole 123 of the connecting seat 12 and the insertion hole 513 of the connecting seat 51 have different diameters.

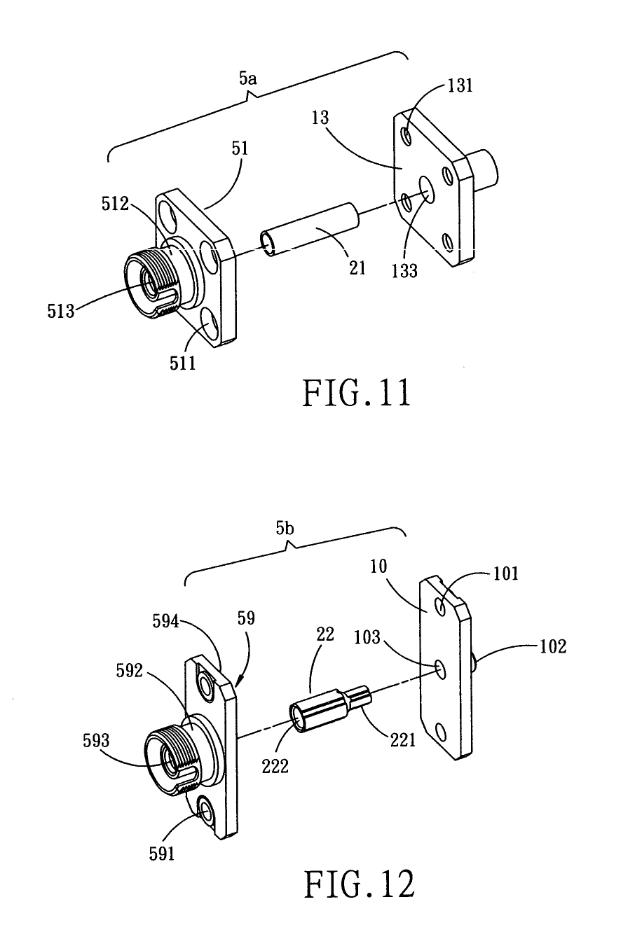

Referring to FIG. 11, an optical fiber connector 5a (FC type) in accordance with another embodiment of the present invention comprises two connecting seats 13 and 51, and a connecting tube 21 mounted between the connecting seats 13 and 51. In addition, the insertion hole 133 of the connecting seat 13 and the insertion hole 513 of the connecting seat 51 have the same diameter.

Referring to FIG. 12, an optical fiber connector Sb (FC type) in accordance with another embodiment of the present invention comprises two connecting seats 10 and 59, and a connecting tube 22 mounted between the connecting seats 10 and 59.

The connecting seat 59 has a first side formed with a plane 594 and a second side integrally formed with a threaded extension portion 592 extended outward therefrom. The extension portion 592 of the connecting seat 59 has a center integrally formed with an insertion hole 593 extended to the plane 594 of the first side for insertion of the second connecting end 222 of the connecting tube 22. Preferably, the insertion hole 593 of the connecting seat 59 is vertical to the plane 594 of the first side. The connecting seat 59 has a periphery formed with a plurality of positioning holes 591. In addition, the insertion hole 103 of the connecting seat 10 and the insertion hole 593 of the connecting seat 59 have different diameters.

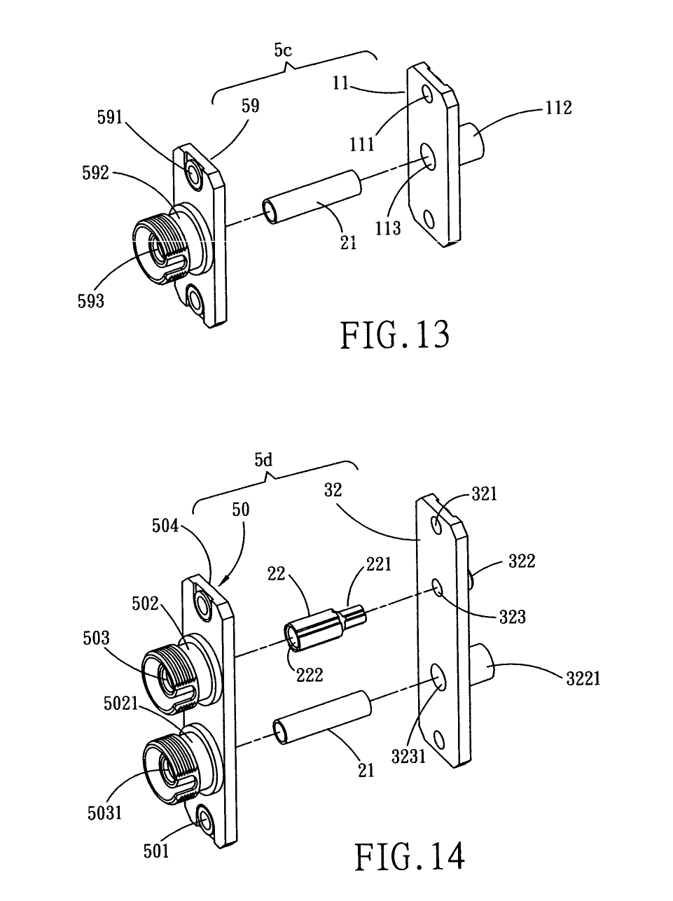

Referring to FIG. 13, an optical fiber connector Sc (FC type) in accordance with another embodiment of the present invention comprises two connecting seats 11 and 59, and a connecting tube 21 mounted between the connecting seats 11 and 59. In addition, the insertion hole 113 of the connecting seat 11 and the insertion hole 593 of the connecting seat 59 have the same diameter.

Referring to FIG. 14, an optical fiber connector Sd (FC type) in accordance with another embodiment of the present invention comprises two connecting seats 32 and 50, and two connecting tubes 21 and 22 each mounted between the connecting seats 32 and 50.

The connecting seat 50 has a first side formed with a plane 504 and a second side integrally formed with two threaded extension portions 502 and 5021 each extended outward therefrom. Each of the extension portions 502 and 5021 of the connecting seat 50 has a center integrally formed with an insertion hole 503 and 5031 extended to the plane 504 of the first side. Preferably, each of the insertion holes 503 and 5031 of the connecting seat 50 is vertical to the plane 504 of the first side. In addition, the insertion holes 503 and 5031 of the connecting seat 50 have the same diameter. The connecting seat 50 has a periphery formed with a plurality of positioning holes 501.

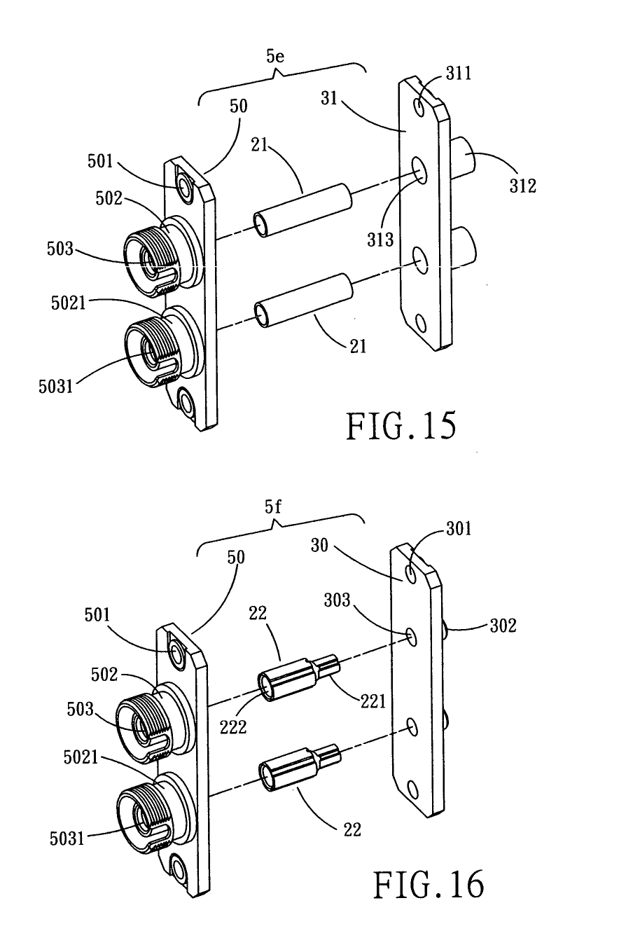

Referring to FIG. 15, an optical fiber connector 5e (FC type) in accordance with another embodiment of the present invention comprises two connecting seats 31 and 50, and two connecting tubes 21 each mounted between the connecting seats 31 and 50.

Referring to FIG. 16, an optical fiber connector Sf (FC type) in accordance with another embodiment of the present invention comprises two connecting seats 30 and 50, and two connecting tubes 22 each mounted between the connecting seats 30 and 50.

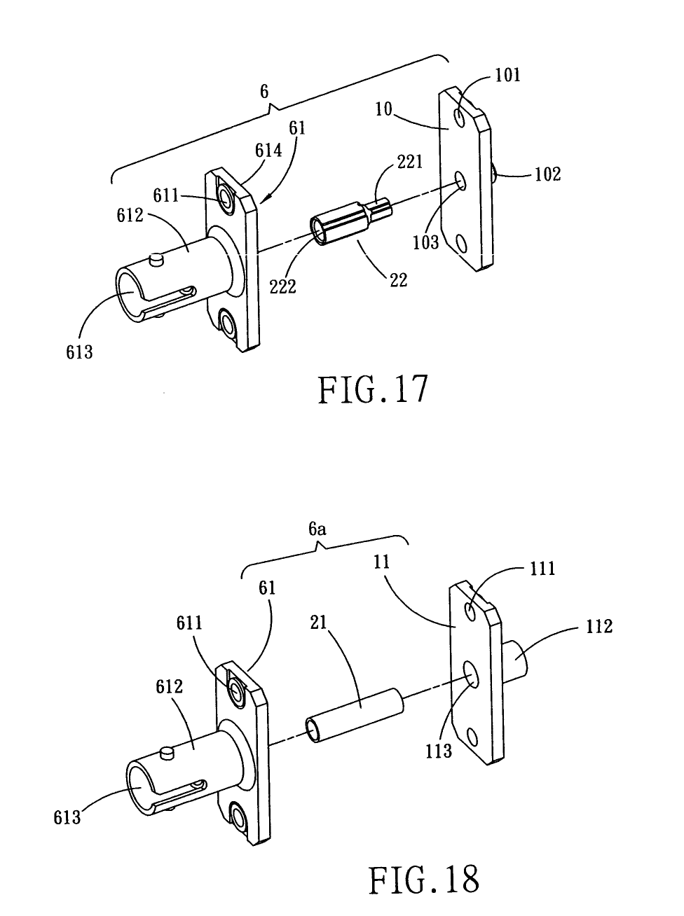

Referring to FIG. 17, an optical fiber connector 6 (ST type) in accordance with another embodiment of the present invention comprises two connecting seats 10 and 61, and a connecting tube 22 mounted between the connecting seats 10 and 61.

The connecting seat 61 has a first side formed with a plane 614 and a second side integrally formed with an extension portion 612 extended outward therefrom. The extension portion 612 of the connecting seat 61 has a center integrally formed with an insertion hole 613 extended to the plane 614 of the first side for insertion of the second connecting end 222 of the connecting tube 22. Preferably, the insertion hole 613 of the connecting seat 61 is vertical to the plane 614 of the first side. The connecting seat 61 has a periphery formed with a plurality of positioning holes 611. In addition, the insertion hole 103 of the connecting seat 10 and the insertion hole 613 of the connecting seat 61 have different diameters.

Referring to FIG. 18, an optical fiber connector 6a (ST type) in accordance with another embodiment of the present invention comprises two connecting seats 11 and 61, and a connecting tube 21 mounted between the connecting seats 11 and 61. In addition, the insertion hole 113 of the connecting seat 11 and the insertion hole 613 of the connecting seat 61 have the same diameter.

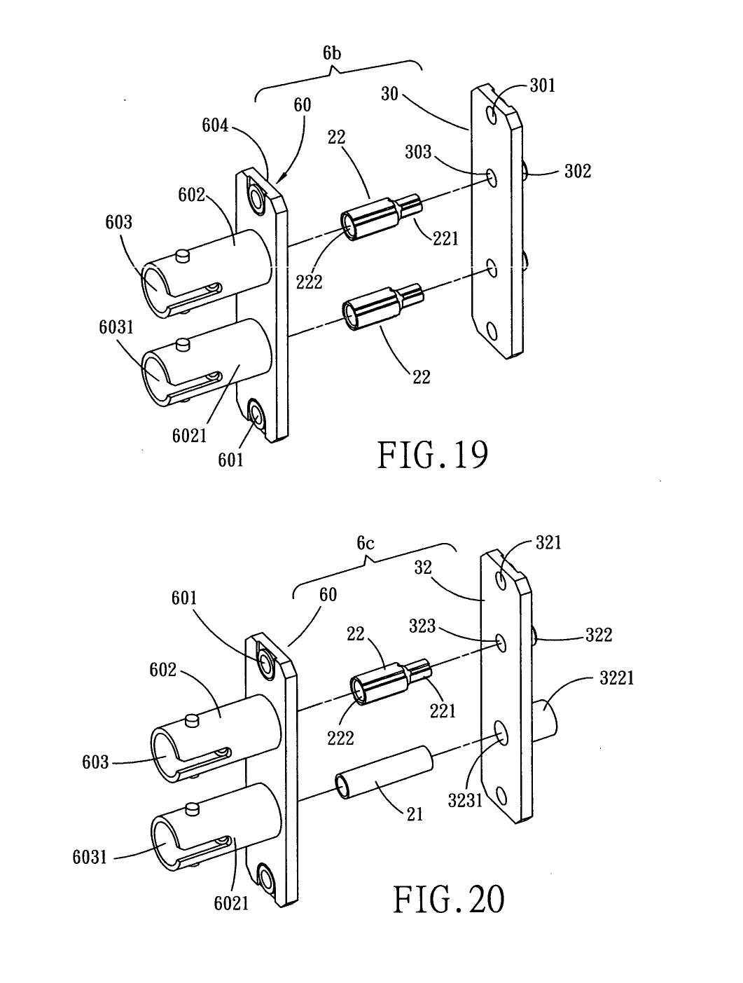

Referring to FIG. 19, an optical fiber connector 6b (ST type) in accordance with another embodiment of the present invention comprises two connecting seats 30 and 60, and two connecting tubes 22 each mounted between the connecting seats 30 and 60.

The connecting seat 60 has a first side formed with a plane 604 and a second side integrally formed with two extension portions 602 and 6021 each extended outward therefrom. Each of the extension portions 602 and 6021 of the connecting seat 60 has a center integrally formed with an insertion hole 603 and 6031 extended to the plane 604 of the first side. Preferably, each of the insertion holes 603 and 6031 of the connecting seat 60 is vertical to the plane 604 of the first side. In addition, the insertion holes 603 and 6031 of the connecting seat 60 have the same diameter. The connecting seat 60 has a periphery formed with a plurality of positioning holes 601. In addition, the insertion hole 303 of the connecting seat 30 and each of the insertion holes 603 and 6031 of the connecting seat 60 have different diameters.

Referring to FIG. 20, an optical fiber connector 6c (ST type) in accordance with another embodiment of the present invention comprises two connecting seats 32 and 60, and two connecting tubes 21 and 22 each mounted between the connecting seats 32 and 60.

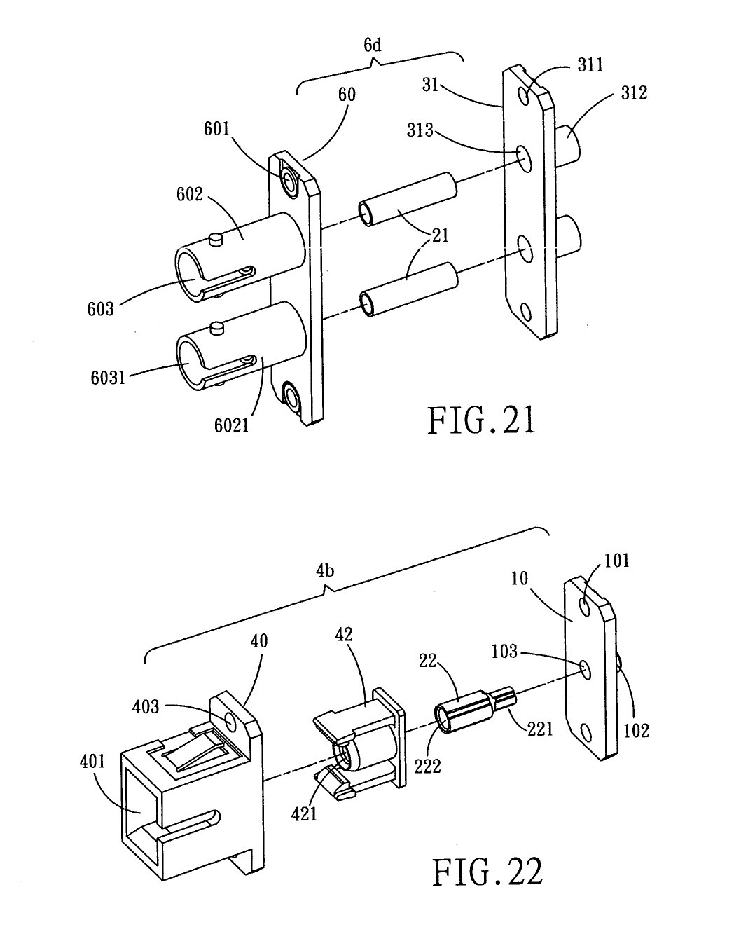

Referring to FIG. 21, an optical fiber connector 6d (ST type) in accordance with another embodiment of the present invention comprises two connecting seats 31 and 60, and two connecting tubes 21 each mounted between the connecting seats 31 and 60. In addition, the insertion hole 313 of the connecting seat 31 and each of the insertion holes 603 and 6031 of the connecting seat 60 have the same diameter.

Referring to FIG. 22, an optical fiber connector 4b in accordance with another embodiment of the present invention comprises two connecting seats 10 and 40, an insertion member 42 inserted into the connecting seat 40, and a connecting tube 22 mounted between the connecting seat 10 and the insertion member 42.

The connecting seat 40 has an inside formed with a receiving recess 401 for receiving the insertion member 42 and has a periphery formed with a plurality of positioning holes 403.

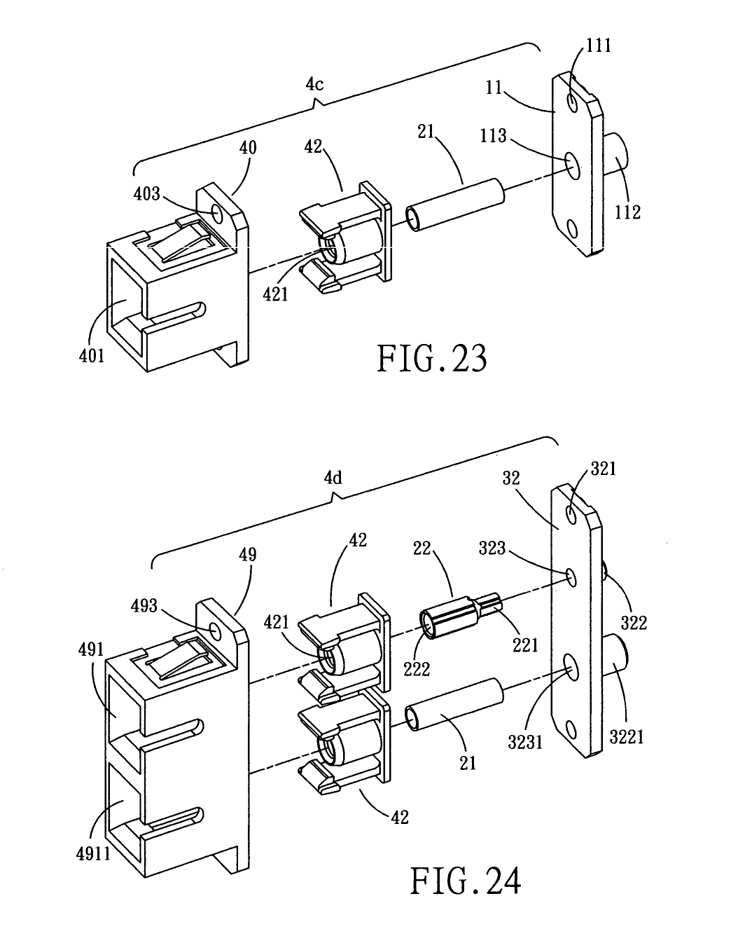

Referring to FIG. 23, an optical fiber connector 4c in accordance with another embodiment of the present invention comprises two connecting seats 11 and 40, an insertion member 42 inserted into the connecting seat 40, and a connecting tube 21 mounted between the connecting seat 11 and the insertion member 42.

Referring to FIG. 24, an optical fiber connector 4d in accordance with another embodiment of the present invention comprises two connecting seats 32 and 49, two insertion members 42 each inserted into the connecting seat 49, and two connecting tubes 21 and 22 each mounted between the connecting seat 32 and the insertion member 49.

The connecting seat 49 has an inside formed with two receiving recesses 491 for receiving the insertion members 42 and has a periphery formed with a plurality of positioning holes 493.

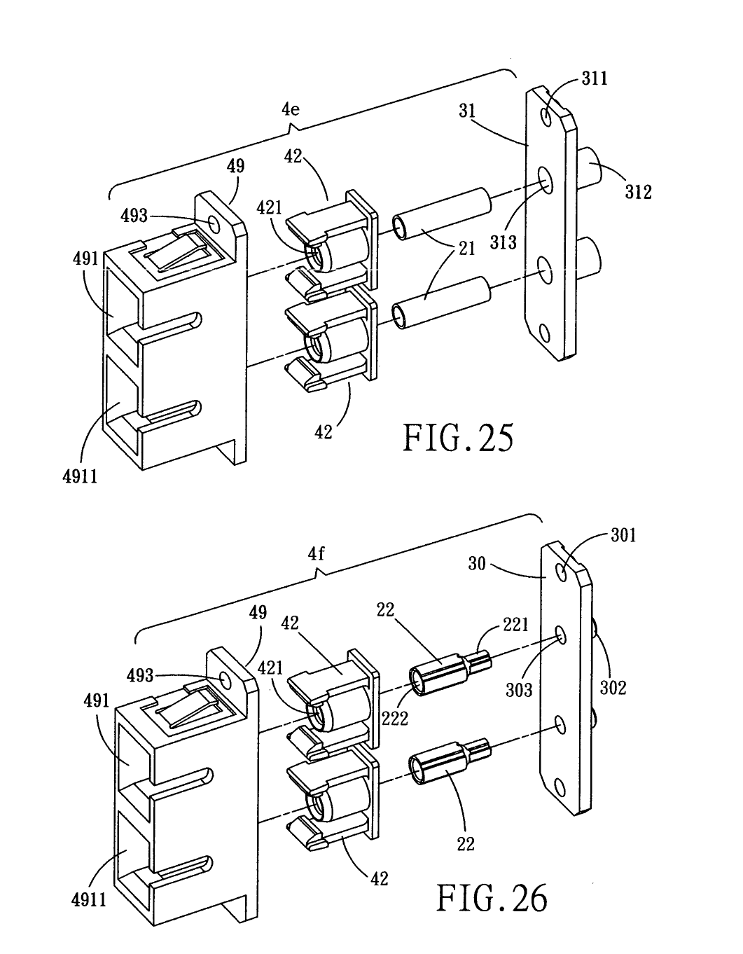

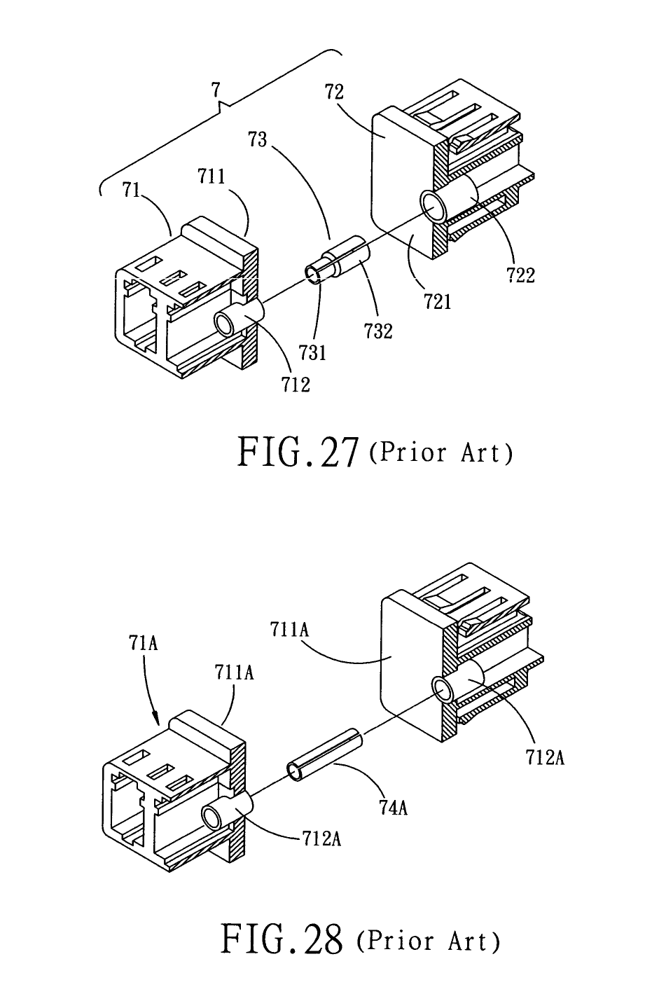

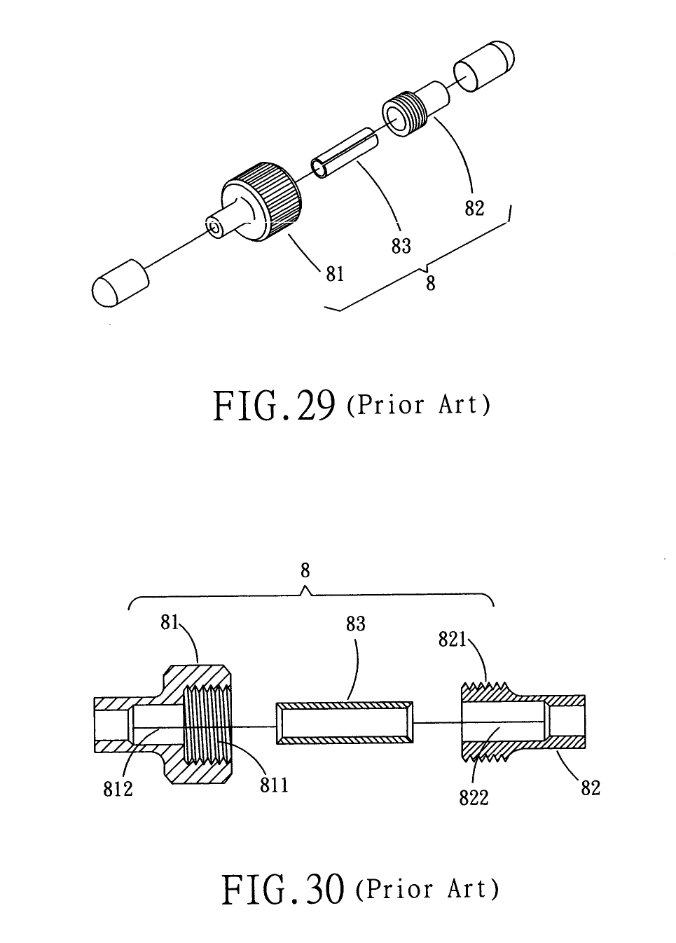

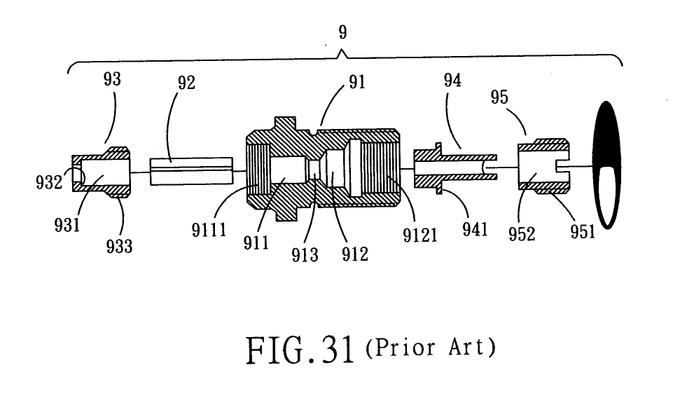

Referring to FIG. 25, an optical fiber connector 4e in accordance with another embodiment of the present invention comprises two connecting seats 31 and 49, two insertion members 42 each inserted into the connecting seat 49, and two connecting tubes 21 each mounted between the connecting seat 31 and the insertion member 49.

Referring to FIG. 26, an optical fiber connector 4f in accordance with another embodiment of the present invention comprises two connecting seats 30 and 49, two insertion members 42 each inserted into the connecting seat 49, and two connecting tubes 22 each mounted between the connecting seat 30 and the insertion member 49.

Accordingly, each of the connecting seats is integrally formed with an extension portion having a center integrally formed with an insertion hole, and the two ends of the connecting tube are inserted into the insertion hole of each of the connecting seats respectively, so that the two optical fiber cables inserted into the connecting tube through the insertion hole of each of the connecting seats can form a co-axial connection state and can be connected with each other exactly. In addition, each of the connecting seats is integrally formed with an extension portion having a center integrally formed with an insertion hole, thereby simplifying the manufacturing procedures, and thereby decreasing costs of fabrication. Further, each of the connecting seats is integrally formed with an extension portion having a center integrally formed with an insertion hole, thereby enhancing the precision of size of each part. Further, the first connecting end and the second connecting end of the connecting tube have different diameters and are co-axial with each other, so that the connecting tube maintains a co-axial connection state, so that the two optical fiber cables can be connected with each other exactly.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. An optical fiber connector, comprising:
two connecting seats each having a first side formed with a plane and a second side integrally formed with at least one insertion hole extended to the plane of the first side; and
at least one connecting tube mounted between the connecting seats and having two ends each inserted into the insertion hole of a respective one of the connecting seats.

2. The optical fiber connector in accordance with claim 1, wherein the planes of the two connecting seats abut each other.

3. The optical fiber connector in accordance with claim 1, wherein the second side of each of the connecting seats is integrally formed with at least one extension portion extended outward therefrom.

4. The optical fiber connector in accordance with claim 3, wherein the extension portion of each of the connecting seats has a center integrally formed with the insertion hole.

5. The optical fiber connector in accordance with claim 1, wherein the insertion hole of each of the connecting seats is vertical to the plane of the first side.

6. The optical fiber connector in accordance with claim 1, wherein each of the connecting seats has a periphery formed with a plurality of positioning holes.

7. The optical fiber connector in accordance with claim 1, wherein the connecting tube is a straight tube.

8. The optical fiber connector in accordance with claim 1, wherein the insertion holes of the connecting seats have the same diameter.

9. The optical fiber connector in accordance with claim 1, wherein the insertion holes of the connecting seats have different diameters.

10. The optical fiber connector in accordance with claim 1, wherein the connecting tube has a first connecting end and a second connecting end having different diameters.

11. The optical fiber connector in accordance with claim 1, wherein the first connecting end and the second connecting end of the connecting tube are co-axial with each other.

12. The optical fiber connector in accordance with claim 1, wherein the second side of one of the connecting seats is integrally formed with two insertion holes having different diameters.

13. The optical fiber connector in accordance with claim 1, further comprising an insertion member inserted into a first one of the connecting seats, wherein the connecting tube is mounted between a second one of the connecting seats and the insertion member.

14. The optical fiber connector in accordance with claim 13, wherein the first connecting seat has an inside formed with a receiving recess for receiving the insertion member.

15. The optical fiber connector in accordance with claim 13, wherein the insertion member has a center integrally formed with an insertion hole for insertion of an end of the connecting tube.

16. The optical fiber connector in accordance with claim 15, wherein the insertion hole of the second connecting seat and the insertion hole of the insertion member have different diameters.

17. The optical fiber connector in accordance with claim 15, wherein the insertion hole of the second connecting seat and the insertion hole of the insertion member have the same diameter.

18. The optical fiber connector in accordance with claim 3, wherein the extension portion of each of the connecting seats is formed with an outer thread.
